(19) United States
(12) Patent Application Publication
(10) Pub. No.: US 2026/0274239 A1
(43) Pub. Date: Sep. 17, 2026

(54) Spring Brake Cylinder for a Vehicle Brake

(71) Applicant: KNORR-BREMSE Systeme fuer Nutzfahrzeuge GmbH, Muenchen (DE)

(72) Inventor: Guillaume LETOT, Caen (FR)

(21) Appl. No.: 19/471,422

(22) PCT Filed: Apr. 11, 2024
(86) PCT No.: PCT/EP2024/059825

§ 371 Date: Oct. 1, 2025

(30) Foreign Application Priority Data
May 15, 2023 (EP) 23173418.7

(51) Int. Cl. B60T 17/08

(52) U.S. Cl. CPC B60T 17/086

(57) ABSTRACT

A spring brake cylinder for a vehicle brake has a hollow release screw with a first throughbore, axially locked against movement relative to a cylinder-bottom for mechanical release of the parking brake, which at a first end is rotatably mounted in the cylinder-bottom and which has a screw head on the outside of the cylinder-bottom and which at a second end runs freely in a bore of the spring brake piston. An axially displaceable, relative to the release screw, pin indicator is arranged in the first throughbore of the release screw. A locking piece has a second throughbore and a first thread which is threaded with a second thread of the release screw. The pin indicator extends through the second throughbore. The pin indicator at a first end, located within the cylinder housing, is axially fixed to a position sensor that includes an indicator cap with a central opening, where the indicator cap and the locking piece are axially displacable to each other. The first end of the pin indicator is designed to snap fit with a central opening of the indicator cap, and at least one first spring is arranged between the indicator cap and a bottom of the bore of the spring brake piston, and the second throughbore of the locking piece is provided with a tool engagement surface which is designed for a rotationally fixed engagement of a rotation tool.

### BACKGROUND AND SUMMARY

The invention refers to a spring brake cylinder for a vehicle brake, to a combined service and spring brake cylinder, to a vehicle brake and to a method for manufacturing a spring brake cylinder.

For servicing and repairing spring brakes of heavy utility vehicles it can be necessary, to mechanically release the spring brakes which are used as parking brakes. The spring brakes are pneumatically activated, where the spring brake cylinders when driving, are deactivated by ventilating them with compressed air. On the other hand, the spring brakes are activated by bleeding the spring brakes cylinders, thereby causing pressure springs to actuate pistons in the spring brake cylinders for activation of the spring brake to the parking brake position.

In a common type of spring brake cylinder, it is possible to mechanically release the parking brake of the vehicle during service and repair of the vehicle, by unscrewing a release screw of the spring brake cylinder. This release screw, by means of a head at its one end, brings the piston with it and thereby compresses the pressure spring so that the parking brake is released and put out of function. From the safety point of view, it is important that service and repair personnel can carry out a visual control of the brake cylinder, in order to unambiguously determine whether the parking brake is activated or has been mechanically released, and is thus not activated. The release screw is axially locked in the brake cylinder and the piston is brought out by a rotationally locked, running nut which has been screwed on to the release screw. Thus, the release screw stays within the brake cylinder, and thus only a screw head for the manipulation of the release screw is located outside of the brake cylinder during the entire release sequence.

EP 0 864 054 B1 describes a generic spring brake cylinder for a vehicle brake. There, the first and of the pin indicator is screwed with the indication cap of the indication body, which is accommodated within a long bore of the piston rod. For the making of the screw connection, the piston rod of the piston has to be manufactured as a separate part, so that the piston rod can only be attached to the piston after the screw connection has been made.

It is an object of the invention to provide a spring brake cylinder for a vehicle brake that is easier to manufacture. Further, also a combined service and spring brake cylinder and a vehicle brake shall be provided that comprise such a spring brake cylinder. Finally, also a method for manufacturing such a spring brake cylinder shall be provided.

This object is solved by the features of the independent claims. The invention starts from a spring brake cylinder for a vehicle brake comprising:
a) a cylinder housing with a casing wall and a cylinder-bottom,
b) a spring brake piston running in said cylinder housing for activation of the brake,
c) a pressure spring positioned between the spring brake piston and the cylinder-bottom for activating the parking brake by mechanically influencing the spring brake piston,
d) a hollow release screw with a first throughbore, axially locked against movement relative to the cylinder-bottom for the mechanical release of the parking brake, which at a first end is rotatably mounted in the cylinder-bottom and which has a screw head on the outside of the cylinder-bottom and which at a second end runs freely in a bore of the spring brake piston,
e) a rotationally locked, running nut threaded onto said release screw, where said running nut has an outer end position at a set distance from said cylinder-bottom and is arranged to, through contact against the spring brake piston, bring the spring brake piston in the axial direction of the release screw when turning the release screw by manipulation of the screw head, and
f) a relative to the release screw axially displaceable pin indicator arranged in the first throughbore of the release screw, and
g) a locking piece that has a second throughbore, and a first thread which is threaded with a second thread of the release screw, where the pin indicator extends through the second throughbore, wherein
h) the pin indicator at a first end, located within the cylinder housing, is axially fixed to a position sensing means which is provided with a contact surface for contact against the running nut, and wherein
i) the pin indicator at a second end has an indication body arranged to visibly protrude out of the screw head of the release screw in case of axial displacement of the pin indicator caused by axial displacement of the running nut from its outer end position, and of the contact surface of the position sensing means, which contact surface is in contact with the running nut, during rotation of the release screw for mechanical release of the parking brake, where
j) the position sensing means includes an indicator cap with a central opening, where the indicator cap and the locking piece are axially displacable to each other.

The invention is characterized in that:
k) the first end of the pin indicator is designed to snap fit with a central opening of the indicator cap,
l) at least one first spring is arranged between the indicator cap and a bottom of the bore of the spring brake piston, and
m) the second throughbore of the locking piece is provided with a tool engagement surface which is designed for a rotationally fixed engagement of a rotation tool.

With such a design of the spring brake cylinder, a simple method for manufacturing the spring brake cylinder, particularly of indications means of the spring brake cylinder, that enable an external visual control of whether the brake is activated or whether it has been mechanically released and thus deactivated, is provided which includes the following steps:
a) positioning of the first spring in the bore of the spring brake piston at the bottom of the bore,
b) providing a preassembled unit of the indicator cap and the locking piece within the bore of the spring brake piston, so that the preassembled unity can contact the first spring,
c) positioning of the release screw together with the nut screwed on in the cylinder housing and in the the bore of the spring brake piston,
d) inserting a rotation tool into the first throughbore of the release screw until it engages the internal tool engagement surface in the second throughbore of the locking piece,
e) turning the rotation tool in a way that first thread of the locking piece is threaded with the second thread of the release screw, where the locking piece is held in a coaxial position with the release screw by the indicator cap, which is axially preloaded by the first spring,
f) removing the rotation tool out of the first throughbore of the release screw,
g) inserting the pin indicator into the first throughbore of the release screw until the first end of the pin indicator axially snap fits with the central opening of the indicator cap, where the indicator cap is axially supported by the first spring.

Particuarly, then, the piston rod and the piston can be manufactured as one piece. Also, the piston rod is a part of the piston.

Preferred embodiments of the invention are presented in the dependent claims.

According to a preferred embodiment, the indicator cap has a cylindrical basic body with the central opening and axial tongues protruding from the basic body, which ends form the contact surface and which radially at least partly embrace the locking piece.

Then, the ends of the tongues can be provided with radially inward protruding clips that axially limit an axial movement of the locking piece relative to the indicator cap. In this way, the locking piece can be secured to the indicator cap.

Additionnally or alternatively, the axial tongues can be provided with guiding means for axially guiding the indicator cap and the locking piece to each other. Particularly, the guiding means can comprise radial inner protrusions of the axial tongues. Further, the guiding means can also be designed, to rotationally lock the indicator cap and the locking piece to each other, particularly during the manufacturing of the spring brake cylinder, as will be described later.

According to an embodiment, the indication body is arranged to be lowered into a recess of the screw headof the release screw.

Further, the contact surface can be brought to accompany the axial displacement of the running nut through spring pressure of at least one spring.

Preferably, the indicator cap is made of an elastic plastic material, particularly to facilitate the manufacture of the snap fit of the first end of the pin indicator with the central opening of the indicator cap. For this, for example, from the central opening of the indicator cap slits are extending in radial direction to provide elasticity of the central bore for the snap fit with the first end of the pin indicator.

Also, preferably, the piston can be provided with a piston rod, in which the bore is formed. Particularly, the piston rod, viewed from the piston, is directed to the cylinder-bottom of the housing.

The indications means of the spring brake cylinder, that enable an external visual control of whether the brake is activated or whether it has been mechanically released and thus deactivated, particularly comprise the indicator pin, the position sensing means (indicator cap), the release screw, the running nut and the locking piece. Optionally, also the second spring is comprised.

The invention also refers to a combined service and spring brake cylinder comprising a spring brake cylinder as described above.

Further, the invention also refers to a vehicle brake comprising the said combined service and spring brake cylinder or the said spring brake cylinder.

The other features and advantages of the invention will become obvious from the following description of preferred embodiments. The drawings show preferred embodiments of the invention.

### BRIEF DESCRIPTION OF THE DRAWINGS

FIG. 1 shows a cut cross-section of a part of a spring brake cylinder according to a preferred embodiment of the invention;

FIG. 2 shows an enlarged detail of FIG. 1, but without cerain parts thereof;

FIG. 3 shows a cut cross-section of indications means of the spring brake cylinder of FIG. 1, that enable an external visual control of whether the brake is activated or whether it has been mechanically released and thus deactivated;

FIG. 4 shows an indicator cap of the indications means of FIG. 3 according to a first embodiment;

FIG. 5 shows an indicator cap of the indicator device of FIG. 3 according to a second embodiment;

FIG. 6 shows a preassembled unit of the indicator cap and a locking piece of the indications means of FIG. 3;

FIG. 7 shows a step of a preferred embodiment of a method of manufacturing the spring brake cylinder of FIG. 1, particularly the indications means, using a rotation tool;

FIG. 8 shows a further step of the preferred embodiment of the method of manufacturing the spring brake cylinder of FIG. 1, particularly the indications means, using the rotation tool;

FIG. 9 shows a flowchart of the steps of the preferred embodiment of the method of manufacturing the spring brake cylinder of FIG. 1, particularly the indications means.

### DETAILED DESCRIPTION OF THE DRAWINGS

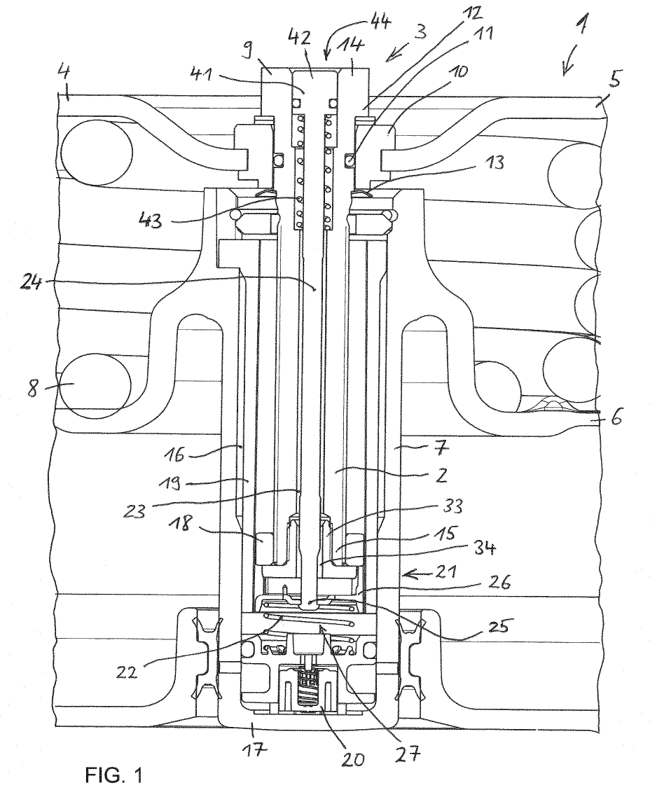

FIG. 1 shows a cut cross-section of a part of a spring brake cylinder 1 of a vehicle parking brake, which is spring activated, according to a preferred embodiment of the invention. It comprises a release screw 2 for the mechanical release of the spring brake. The spring brake cylinder 1 is provided with an indication device 3, which enables an external visual control of whether the parking brake is activated or whether it has been mechanically released and thus deactivated and which will be described in detail later.

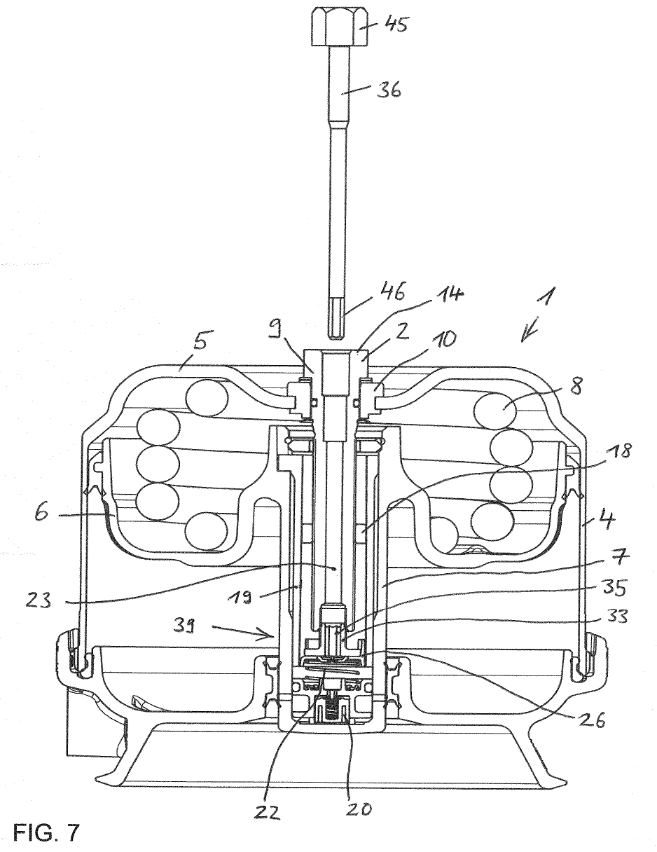

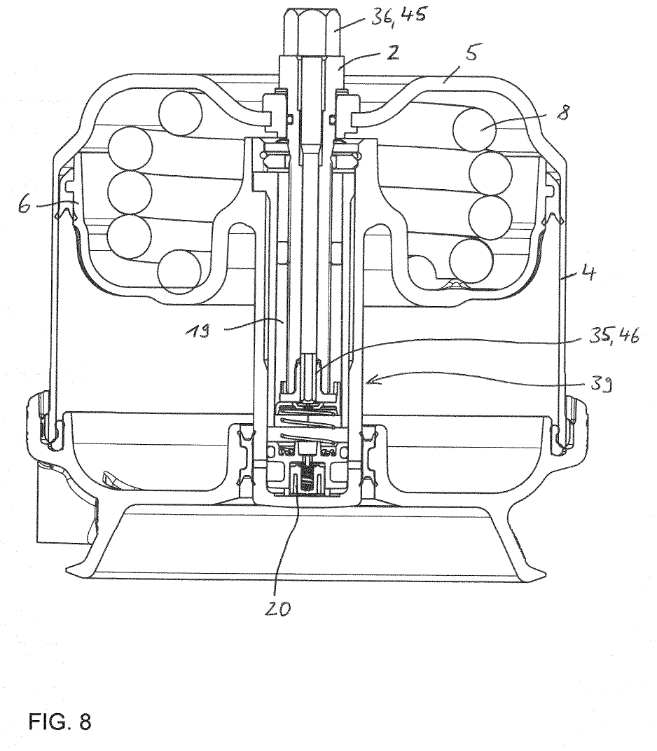

The spring brake cylinder 1 is of the pneumatic kind and is shown partially in a cut view, where the connections for compressed air have not been shown. The rest of the spring brake cylinder 1 is of a well-known kind, for which reason it will not be described in detail here. From FIG. 1, FIG. 7 and FIG. 8, it can be seen that the spring brake cylinder 1 comprises a cylinder housing 4 with a casing wall and a cylinder bottom 5. A rotationally locked spring brake piston 6 equipped with a piston rod 7 for the activation of the brake runs inside the cylinder housing 4. The parking brake is not shown, but can for example be of a commonly known disc brake kind, with brake caliper and brake pads. The spring brake piston 6 is sealed against the casing wall of the cylinder housing 4 by means of a piston sealing of a suitable elastic material.

A pressure spring 8 of the spiral kind is positioned between the spring brake piston 6 and the cylinder bottom 5 of the cylinder housing 4 in order to activate the parking brake by mechanically loading the spring brake piston 6.

The release screw 2 for the mechanical release of the parking brake is at a first end 9 rotatably mounted in the cylinder bottom 5 via a bearing bush 10. The bearing bush 10 has been fixed to the cylinder bottom 5, e.g. by pressing. An O-ring seals 11 between the release screw 2 and the bearing bush 10 (and thereby the cylinder housing 4) in order to achieve protection of all internal parts of the spring brake cylinder 1 against intrusion of moisture and dirt and accompanying corrosion. The release screw 2 is axially locked against movement relative to the cylinder bottom 5 by means of a circumferential flange 12 and a locking ring 13, which prevents the release screw 2 from slipping out. The release screw 2 extends at the first end 9 outside of the cylinder bottom 5 in which place it has the flange 12 and a screw head 14 of, for example, hexagonal shape for use of a suitable torque tool to turn the release screw 2. The release screw 2 extends axially through the center line of the pressure spring 8 and at a second end 15 it runs freely in a blind bore 16 of the piston rod 7, where the blind bore 16 is limited by a piston rod bottom 17, which faces away from the cylinder bottom 5.

The release screw 2 is provided with an external thread which extends along the main length of the release screw 2. A running nut 18 is screwed with an internal thread onto the external thread of the release screw 2. The running nut 18 on its peripheral outside is of non-round shape, in the example shown a hexagonal shape, in order to lock it rotationally in relation to a sleeve 19 rotatably locked within the piston rod 7, by means of a corresponding shape in the radial inner diameter of the sleeve 19.

The second end 15 of the release screw 2 is located vis-à-vis the piston rod bottom 17, where here, e.g. a breathing valve 20 is accommodated, which function is not of interest in the context of the invention. Between the breathing valve 20 and a position sensing means 21 arranged on the second end 15 of the release screw 2, a first spring 22, e.g. of the helical kind is provided. The breathing valve 20 is optional and can also be omitted.

In FIG. 1, the running nut 18 is shown in an outer end position at a set distance from the cylinder bottom 5. The running nut 18 is arranged to, here particularly through direct or indirect contact with the piston rod 7, bring the spring brake piston 6 with it in the axial direction of the release screw 2 when turning the release screw 2 by manipulation of the screw head 14. In so doing, the pressure spring 8 is also compressed.

The release screw 2 is provided with a central first throughbore 23 which extends in co-parallel with the symmetry axis of the release screw 2. A pin indicator 24 extends freely through the first throughbore 23 where it is axially displaceable relative to the release screw 2. The pin indicator 24 can be both, a solid bar or a hollow pipe.

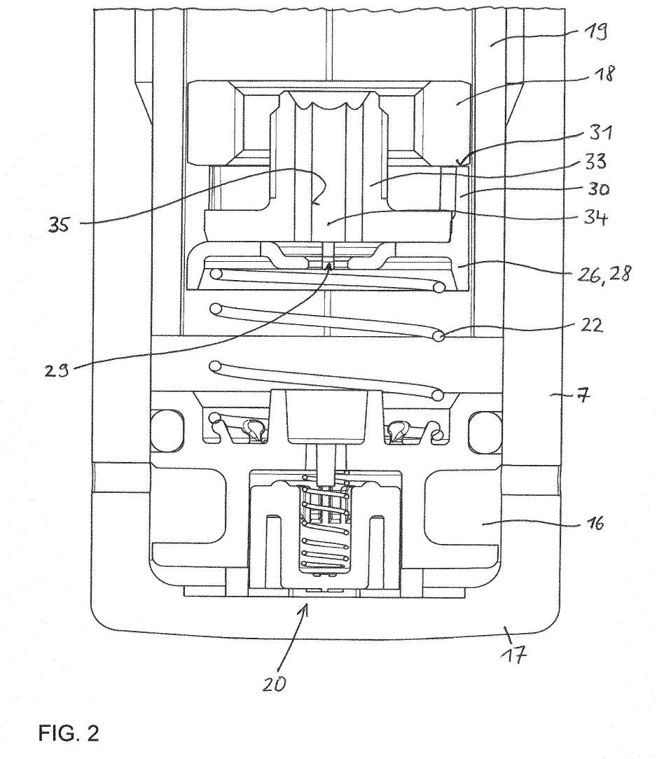

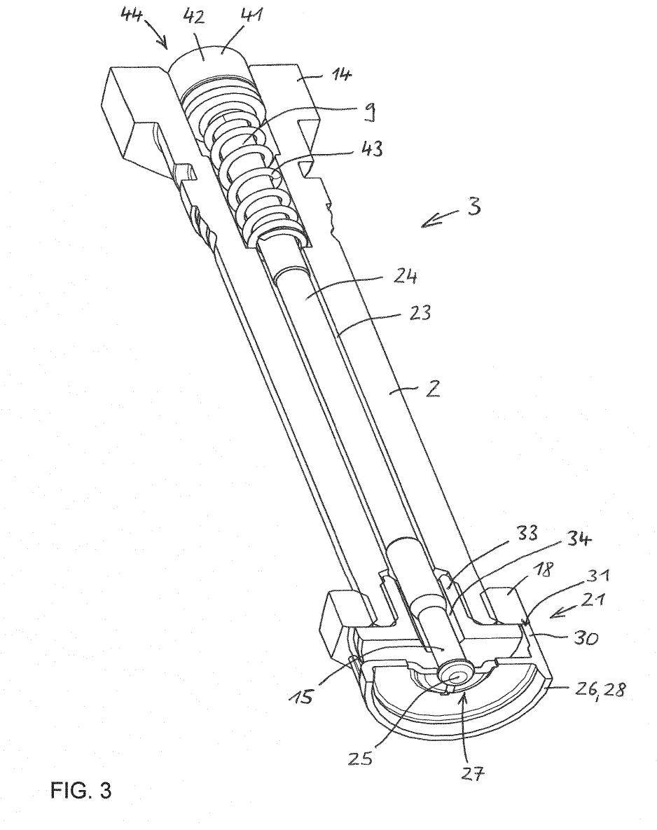

The pin indicator 24 is at a first end 25, located within the cylinder housing 4 and connected with an indicator cap 26, by a snap fit 27. For the snap fit 27, the first end 25 of pin indicator 24 is e.g. formed as head with a radial protrusion (FIG. 3). The indicator cap 26 e.g. has a cylindrical basic body 28 with a central opening 29 and axial tongues 30 protruding from the basic body 28, which ends form a contact surface 31. The contact surface 31 of the axial tongues 30 of the indicator cap 26 are designed to come in contact with a front face of the running nut 18 when it has reached the second end 15 of the release screw, as shown in FIG. 1 and FIG. 3. In FIG. 2, the pin indicator 24 and the release screw 2 are not shown.

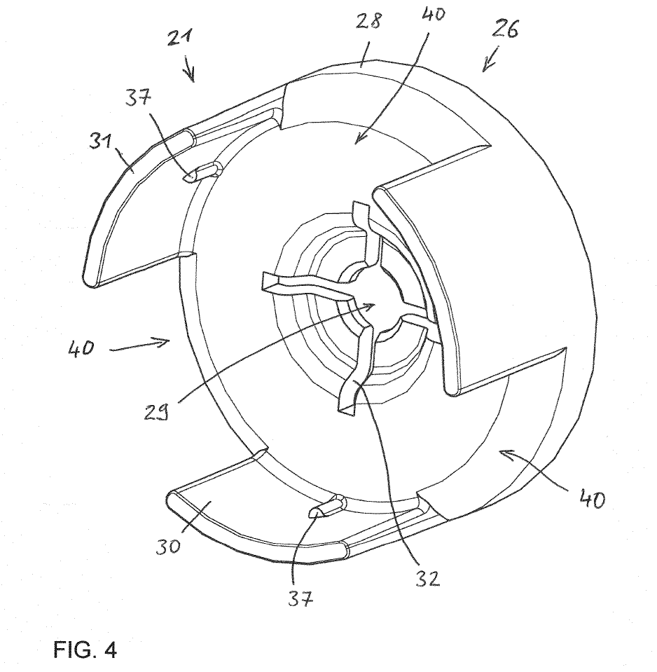

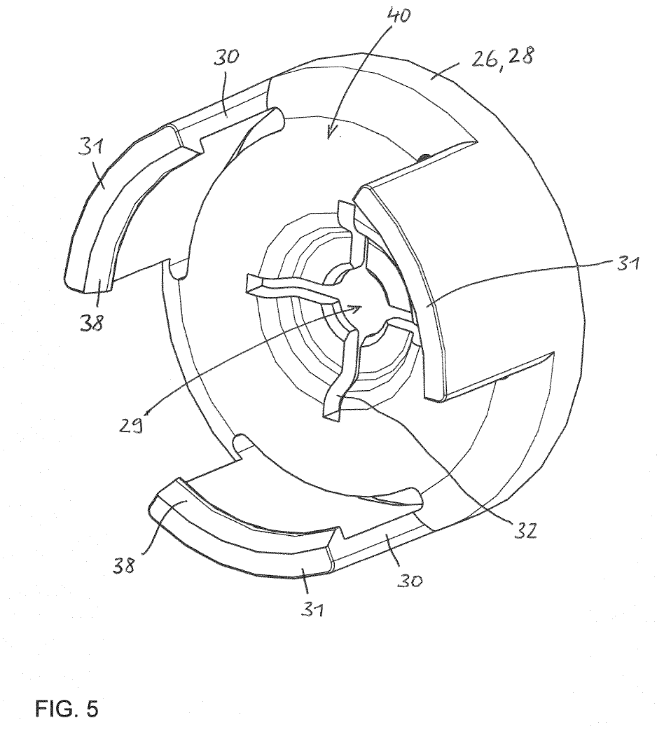

Embodiments of the indicator cap 26 are shown in FIG. 4 and in FIG. 5. For the snap fit 27, particularly slits 32 are extending from the central opening 29 of the basic body 28 in radial direction to provide elasticity of the central opening 29 for the snap fit 27, when the first end 25 of the pin indicator 24 intrudes into it. Particularly, the indicator cap 26 is made of an elastic plastic material as a whole. The indicator cap 26 is part of the position sensing means 21 which sense the position of the running nut 18 when it has been screwed into the area of the second end 15 of the release screw 2.

Further, a locking piece 33 that has a second throughbore 34, and a first, for example radial outer thread which is threaded with a second, for example radial inner thread of the release screw 2, is arranged within the first throughbore 23 of the release screw 2, where the pin indicator 24 extends also through said second throughbore 34. The second throughbore 34 of the locking piece 33 is provided with an internal tool engagement surface 35, which is designed for a rotationally fixed engagement of a complementary tool engagement surface 46 of a rotation tool 36 (FIG. 7). Further, the axial tongues 30 protruding from the basic body 28 of the indicator cap 26, which ends form the contact surface 31 with the running nut 18, radially embrace the locking piece 33, so that the ends of these axial tongues 30 can come into contact with the front surface of the running nut 18. Further, to provide a radial elasticity of the tongues 30, peripheral recesses 40 can be arranged between the tongues 30.

According to one embodiment of the indicator cap 26 shown in FIG. 4, the axial tongues 30 of the indicator cap 26 can be provided with guides for axially guiding the locking piece 33, particularly when threaded with the release screw 2, as will be explained later. For instance, these guides can comprise radial inner protrusions 37 of the axial tongues 30. These radial inner protrusions 37 can be guided in axial recesses (not shown) in the outer diameter of the locking piece 33.

Alternatively, or additionally, according to another embodiment of the of the indicator cap 26 shown in FIG. 5, the ends of the tongues 30 can be provided with radially inward protruding clips 38 that axially limit an axial movement of the locking piece 33 relative to the indicator cap 26 In this way, the locking piece 33 can be secured to the indicator cap 26 and vice versa.

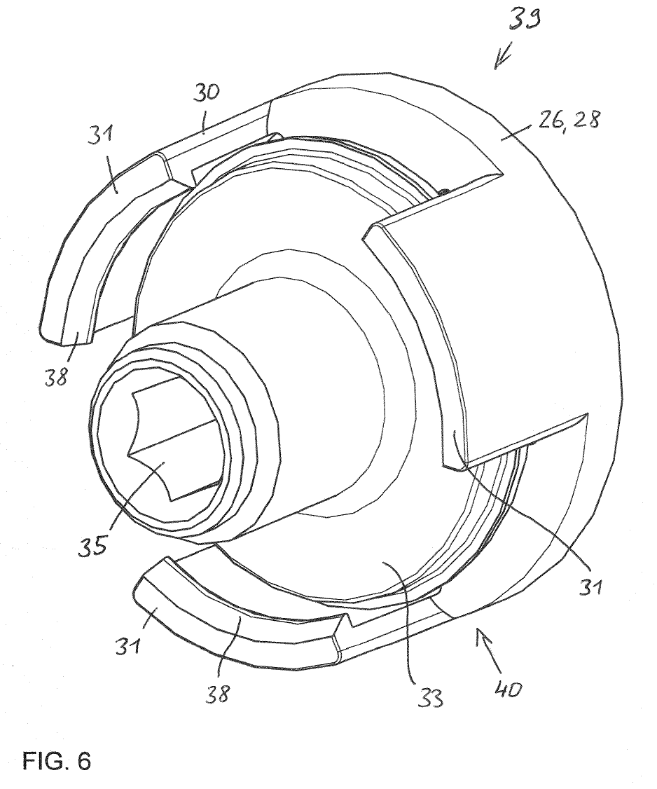

FIG. 6 shows a pre-assembled unit 39 of the indicator cap 26 and the locking piece 33, where the tongues 30 of the indicator cap 26 embrace and particularly contact the outer surface or diameter of the locking piece 33. As a result, the indicator cap 26 is arranged to move axially in respect to the locking piece 33 and vice versa, particulary guided by the guiding means as explained above.

The pin indicator 24 is at a second end 41 equipped with an indication body 42 e.g. in the shape of a indication piston, arranged to visibly protrude out of the screw head 14 of the release screw 2 in case of axial displacement of the pin indicator 24, caused by axial displacement of the running nut 18 from its outer end position shown in FIG. 1, and of the contact surface 31 of the indicator cap 26, which contact surface 31 is then no more in contact with the running nut 18, during rotation of the release screw 2 for mechanical release of the parking brake.

The contact surface 31 of the axial tongues 30 of the indicator cap 26 is here brought to move with the axial movement of the running nut 18 through spring pressure from a second spring 43 which at its one end is in contact with a seat in the first throughbore 23 of the release screw 2 and which at its other end is in contact with the indication body 42, as can best be seen from FIG. 3.

As a result, the indications means 3 of the spring brake cylinder 1, that enable an external visual control of whether the parking brake is activated or whether it has been mechanically released and thus deactivated, particularly comprise the pin indicator 24, the position sensing means (indicator cap) 26, the release screw 2, the running nut 18 and the locking piece 33. Optionally, also the second spring 43 is comprised therein. These indication devices 3 are shown in detail in FIG. 3.

During normal operating function of the spring brake cylinder 1 the indication body 42 is particularly completely lowered into a surrounding recess 44 in the screw head 14 of the release screw 2 (FIG. 1). Immediately when the running nut 18 leaves its outer end position, the indication body 42 will protrude from the recess 44. The indication body 42 is preferably coloured in a warning colour, preferably red, so that service personnel will obtain a clear visual warning-signal when the parking brake has been mechanically released. The indication body 42 can be sealed with an O-ring against the wall of the recess 44.

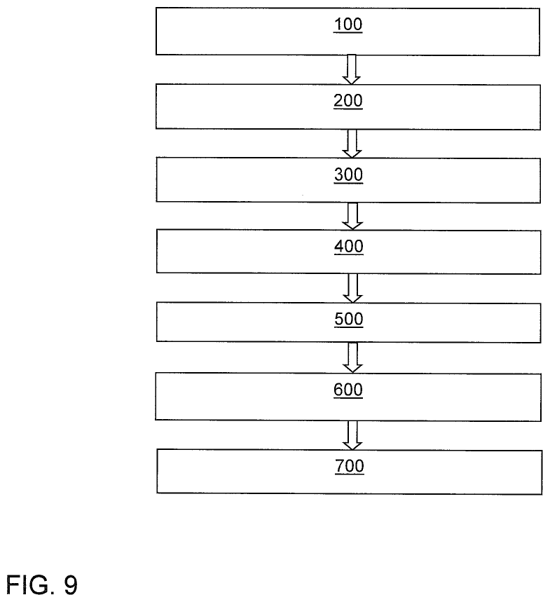

FIG. 9 shows a flowchart of the steps of a preferred embodiment of a method of manufacturing the spring brake cylinder 1, particularly for manufacturing the indication device 3 of the spring brake cylinder 1.

The method starts with the spring brake cylinder 1 in a condition, where the release screw 2 with the running nut 18 threaded thereon have already been mounted in the cylinder housing 4 and where also the sleeve 19 has been mounted in the blind bore 16 of the piston rod 7.

Then, in a step 100, the first spring 22 is positioned in the blind bore 16 of the piston rod 7 at the piston rod bottom 17.

In a next step 200, the pre-assembled unit 39 (FIG. 6) of the indicator cap 26 and the locking piece 33 is positioned within the blind bore 16 of the piston rod 7, so that the pre-assembled unit 39 can contact the first spring 22, particularly with the cylindrical basic body 28 of the indicator cap 26. Then, the first spring 22 is axially arranged between the breathing valve 20 or the piston rod bottom 17, respectively, and the indicator cap 26. In the pre-assembled unit 29 (FIG. 6), the indicator cap 26 and the locking piece 33 are fixed to each other against relative rotation, in particular by the protrusions 37 (FIG. 4) and/or by frictional locking. In this pre-assembled condition of the unit 39, it is possible, that the locking piece 33 and the indicator cap 26 can move axially to each other.

In a following step 300, the release screw 2 together with the running nut 18 screwed on is positioned on the one hand side in the bearing bush 10 of the cylinder housing 4, and on the other hand side in the the blind bore 16 of the piston rod 7, so that the second through bore 34 of the locking piece 33 is essentially coaxial with the first throughbore 23 of the release screw 2, and the first, for example radial outer thread of the locking piece 33 is essentially coaxial the second, for example radial inner thread of the release screw 2. When this has been done, the situation is shown in FIG. 7.

In a next step 400, the rotation tool 36 is inserted into the first throughbore 23 of the release screw 2 until it engages the tool engagement surface 35 in the second throughbore 34 of the locking piece 33, as can be seen in FIG. 8. Particularly, the rotation tool 36 has a tool head 45, which has a diameter, that the tool head 45 can first, be supported on the screw head 14 of the release screw 2, and second, has an e.g. hexagonal cross section, so it can be engaged by a further tool, e.g. a wrench to be turned.

In a following step 500, the rotation tool 36 is turned in a way that the first thread of the locking piece 33 is threaded with the second thread of the release screw 1, where the locking piece 33 is held in a coaxial position with the release screw 1 by the indicator cap 26, which is stabilized by the preload of the first spring 22 and by the inner diameter of the sleeve 19, which precents the indicator cap 26 from tilting. When the first thread of the locking piece 33 is threaded with the second thread of the release screw 1, the indicator cap 26 is rotated together with the locking piece 33 and the rotation tool 36, where the release screw 2 is locked rotationally e.g. by a torque tool being engaged with the screw head 14.

In a next step 600, the rotation tool 36 is removed out of the first throughbore 23 of the release screw 2.

In a following step 700, the pin indicator 24 together with the second spring 43 is inserted into the first throughbore 23 of the release screw 2 until the first end 25 of the pin indicator 24 axially snap fits with the elastic central opening 29 of the indicator cap 26, whereby the indicator cap 26 is axially supported by the first spring 22.

When the metod is finished, the pin indicator 24, the indication body 42 and the indicator cap 26 connected thereto can axially move in respect to the release screw 2 and the locking piece 33 connected thereto depending on the position ot the running nut 18, preloaded by the second spring 43, as can be best seen in FIG. 3. During this axial movement, the tongues 30 of the indicator cap 26 particularly can slide along the radial outer surface of the locking piece 33.

### LIST OF REFERENCES

1 spring brake cylinder
2 release screw
3 indication device
4 cylinder housing
5 cylinder bottom
6 spring brake piston
7 piston rod
8 pressure spring
9 first end
10 bearing bush
11 O-ring
12 flange
13 locking ring
14 screw head
15 second end
16 blind bore
17 piston rod bottom
18 running nut
19 sleeve
20 breathing valve
21 position sensing means
22 first spring
23 first throughbore
24 pin indicator
25 first end
26 indicator cap
27 snap fit
28 basic body
29 central opening
30 tongues
31 contact surface
32 slits
33 locking piece
34 second throughbore
35 tool engagement surface
36 rotation tool
37 protrusions
38 clips
39 pre-assembled unit
40 peripheral recesses
41 second end
42 indication body
43 second spring
44 recess
45 tool head
46 tool engagement surface

1.-13. (canceled)

14. A spring brake cylinder for a vehicle brake, comprising:
a) a cylinder housing with a casing wall and a cylinder-bottom;
b) a spring brake piston running in said cylinder housing for activation of the vehicle brake;
c) a pressure spring positioned between the spring brake piston and the cylinder-bottom for activating a parking brake by mechanically influencing the spring brake piston;
d) a hollow release screw with a first throughbore, axially locked against movement relative to the cylinder-bottom for the mechanical release of the parking brake, which at a first end is rotatably mounted in the cylinder-bottom and which has a screw head on the outside of the cylinder-bottom and which at a second end runs freely in a bore of the spring brake piston;
e) a rotationally locked, running nut threaded onto said release screw, where said running nut has an outer end position at a set distance from said cylinder-bottom and is arranged to, through contact against the spring brake piston, bring the spring brake piston in the axial direction of the release screw when turning the release screw by manipulation of the screw head; and
f) an axially displaceable, relative to the release screw, pin indicator arranged in the first throughbore of the release screw; and
g) a locking piece that has a second throughbore, and a first thread which is threaded with a second thread of the release screw, where the pin indicator extends through the second throughbore, wherein
h) the pin indicator at a first end, located within the cylinder housing, is axially fixed to a position sensor which is provided with a contact surface for contact against the running nut; and wherein
i) the pin indicator at a second end has an indication body arranged to visibly protrude out of the screw head of the release screw in case of axial displacement of the pin indicator caused by axial displacement of the running nut from its outer end position, and of the contact surface of the position sensor, which contact surface is in contact with the running nut, during rotation of the release screw for mechanical release of the parking brake, where
j) the position sensor includes an indicator cap with a central opening, where the indicator cap and the locking piece are axially displacable to each other,
k) the first end of the pin indicator is configured to snap fit with a central opening of the indicator cap,
l) at least one first spring is arranged between the indicator cap and a bottom of the bore of the spring brake piston, and
m) the second throughbore of the locking piece is provided with a tool engagement surface which is configured for a rotationally fixed engagement of a rotation tool.

15. The spring brake cylinder according to claim 14, wherein
the indicator cap has a basic body with the central opening and axial tongues protruding from the basic body, which ends form the contact surface and which radially at least partly embrace the locking piece.

16. The spring brake cylinder according to claim 15, wherein
ends of the axial tongues are provided with radially inward protruding clips that axially limit an axial movement of the locking piece relative to the indicator cap.

17. The spring brake cylinder according to claim 16, wherein
the axial tongues are provided with guides for axially guiding the indicator cap and the locking piece to each other.

18. The spring brake cylinder according to claim 17, wherein
the guides comprise radial inner protrusions of the axial tongues.

19. The spring brake cylinder according to claim 14, wherein
the indication body is arranged to be lowered into a recess of the screw head of the release screw.

20. The spring brake cylinder according to claim 14, wherein
the contact surface is brought to accompany the axial displacement of the running nut through spring pressure of a second spring.

21. The spring brake cylinder according to claim 14, wherein
the indicator cap is made of an elastic plastic material.

22. The spring brake cylinder according to claim 14, wherein
from the central opening of the indicator cap, slits extend in a radial direction to provide elasticity of the central opening for the snap fit with the first end of the pin indicator.

23. The spring brake cylinder according to claim 14, wherein
the spring brake piston is provided with a piston rod, in which the bore is formed.

24. A combined service and spring brake cylinder comprising a spring brake cylinder according to claim 14.

25. A vehicle brake comprising a combined service and spring brake cylinder according to claim 24,

26. A method for manufacturing a spring brake cylinder having:
a cylinder housing with a casing wall and a cylinder-bottom;
a spring brake piston running in said cylinder housing for activation of the vehicle brake;
a pressure spring positioned between the spring brake piston and the cylinder-bottom for activating a parking brake by mechanically influencing the spring brake piston;
a hollow release screw with a first throughbore, axially locked against movement relative to the cylinder-bottom for the mechanical release of the parking brake, which at a first end is rotatably mounted in the cylinder-bottom and which has a screw head on the outside of the cylinder-bottom and which at a second end runs freely in a bore of the spring brake piston;
a rotationally locked, running nut threaded onto said release screw, where said running nut has an outer end position at a set distance from said cylinder-bottom and is arranged to, through contact against the spring brake piston, bring the spring brake piston in the axial direction of the release screw when turning the release screw by manipulation of the screw head;
an axially displaceable, a relative to the release screw, pin indicator arranged in the first throughbore of the release screw; and
a locking piece that has a second throughbore, and a first thread which is threaded with a second thread of the release screw, where the pin indicator extends through the second throughbore, wherein
the pin indicator at a first end, located within the cylinder housing, is axially fixed to a position sensor which is provided with a contact surface for contact against the running nut; and wherein
the pin indicator at a second end has an indication body arranged to visibly protrude out of the screw head of the release screw in case of axial displacement of the pin indicator caused by axial displacement of the running nut from its outer end position, and of the contact surface of the position sensor, which contact surface is in contact with the running nut, during rotation of the release screw for mechanical release of the parking brake, where
the position sensor includes an indicator cap with a central opening, where the indicator cap and the locking piece are axially displacable to each other,
the first end of the pin indicator is configured to snap fit with a central opening of the indicator cap,
at least one first spring is arranged between the indicator cap and a bottom of the bore of the spring brake piston, and
the second throughbore of the locking piece is provided with a tool engagement surface which is configured for a rotationally fixed engagement of a rotation tool,
the method comprising the steps of:
a) positioning the first spring in the bore of the spring brake piston at the bottom of the bore;
b) providing a pre-assembled unit of the indicator cap and the locking piece within the bore of the spring brake piston, so that the preassembled unit can contact the first spring;
c) positioning the release screw together with the running nut screwed on in the cylinder housing and in the bore of the spring brake piston;
d) inserting a rotation tool into the first throughbore of the release screw until it engages the tool engagement surface in the second throughbore of the locking piece;
e) turning the rotation tool in such a way that the first thread of the locking piece is threaded with the second thread of the release screw, where the locking piece is held in a coaxial position with the release screw by the indicator cap, which is axially preloaded by the first spring;
f) removing the rotation tool out of the first throughbore of the release screw; and
g) inserting the pin indicator into the first throughbore of the release screw until the first end of the pin indicator axially snap fits with the central opening of the indicator cap, where the indicator cap is axially supported by the first spring.
